(19) United States
(12) Patent Application Publication
(10) Pub. No.: US 2005/0272492 A1
(43) Pub. Date: Dec. 8, 2005

(54) Method and system for synchronizing a game system with a physics system

(75) Inventor: John B. Stelly III, Bothell, WA (US)

Correspondence Address: DARBY & DARBY P.C., P. O. BOX 5257, NEW YORK, NY, 10150-5257, US

(73) Assignee: Valve Corporation, Bellevue, WA (US)

(21) Appl. No.: 10/840,505

(22) Filed: May 6, 2004

(51) Int. Cl. G06F 19/00; G06F 17/00

(52) U.S. Cl. 463/1

(57) ABSTRACT

A system, apparatus, and method are directed to synchronizing a result from a physics engine with a result from a game logic. Synchronization of results may be achieved by employing an arbitration rule to determine which result may dictate an overall game action. The game logic is enabled to determine a result for a game logic entity. The physics engine determines a result for an associated physics proxy. Upon determination of the result for the game logic entity, the physics engine determines the result for the associated physics proxy. If it is determined from the physics result that an interaction between objects occurred, the physics result is employed to synchronize the game logic result; otherwise, the result for the game logic entity is employed to drive the result for the physics proxy.

### FIELD OF THE INVENTION

The present invention relates to computer game systems, and in particular, but not exclusively, to a system and method for synchronizing a game and a physics entity system.

### BACKGROUND OF THE INVENTION

As many devoted computer gamers may be aware, the overall interactive entertainment of a computer game may be greatly enhanced with the presence of a realistic physics model. Physics models often provide the mathematical computations for interactions, movement, forces, torques, and the like, for a three dimensional environment and its characters. However, creating a robust and flexible physical model that is also computationally efficient is a considerable challenge. Such physical models may be difficult to design, challenging to code, and even more difficult to debug. Creating the physical model to operate realistically in real-time may be even more difficult.

Today, there are a number of off-the-shelf physics models that are available, liberating many game developers, and other dynamic three-dimensional program developers, from the chore of programming this component, themselves. However, integration of such physics models with a game model that describes the environment and its characters often remains complex. An improper integration of the physics model with the game model may be visible to the computer gamer by such actions as a character seeming to walk through an object, another character, or the like, as well as other non-realistic actions, reactions, and appearances. Such problems tend to diminish the overall enjoyment in the game. Thus, there is a need in the industry for improved approaches to the integration of the physics model with the game model. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 illustrates one embodiment of an environment in which the invention operates;

FIG. 2 illustrates a functional block diagram of one embodiment of a network device configured to operate with a game server;

FIG. 3 illustrates a function block diagram of one embodiment of the game server of FIG. 2; and

FIG. 4 illustrates a flow diagram generally showing one embodiment of a process of synchronizing a game logic result with a physics proxy result, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The phrase “in one embodiment,” as used herein does not necessarily refer to the same embodiment, although it may. Similarly, the phrase “in another embodiment,” as used herein does not necessarily refer to a different embodiment, although it may.

The term “based on” is not exclusive and provides for being based on additional factors not described, unless the context clearly dictates otherwise.

Briefly stated, the present invention is directed to a system, apparatus, and method for synchronizing a result from a physics engine with a result from a game logic. Synchronization of results may be achieved by employing an arbitration rule to determine which result may dictate an overall game action. The game logic is enabled to determine a result for a game logic entity. The physics engine determines a result for an associated physics proxy. Upon determination of the result for the game logic entity, the physics engine determines the result for the associated physics proxy. If it is determined from the physics result that an interaction between objects occurred, the physics result is employed to synchronize the game logic result; otherwise, the result for the game logic entity is employed to drive the result for the physics proxy. In one embodiment, an entity is modeled in the physics engine to have a dimension that is epsilon smaller than the associated game logic entity. In a further embodiment, epsilon is about the dimension that may be determined during a computational frame cycle between the game logic and the physics engine.

Illustrative Operating Environment

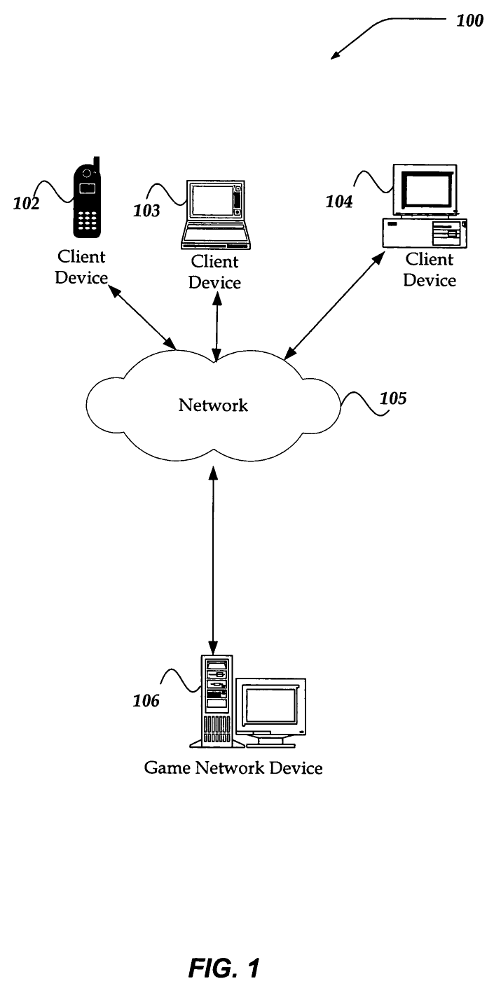

FIG. 1 illustrates one embodiment of an environment in which the invention may operate. However, not all of these components may be required to practice the invention, and variations in the arrangement and type of the components may be made without departing from the spirit or scope of the invention.

As shown in the figure, system 100 includes client devices 102-104, network 105, and Game Network Device (GND) 106. Network 105 enables communication between client devices 102-104, and GND 106.

Generally, client devices 102-104 may include virtually any computing device capable of connecting to another computing device to send and receive information, including game information, and other interactive information. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, radio frequency (RF) devices, infrared (IR) devices, integrated devices combining one or more of the preceding devices, or virtually any mobile device, and the like. Similarly, client devices 102-104 may be any device that is capable of connecting using a wired or wireless communication medium such as a PDA, POCKET PC, wearable computer, and any other device that is equipped to communicate over a wired and/or wireless communication medium.

Client devices 102-104 may further include a client application, and the like, that is configured to manage the actions described above.

Moreover, client devices 102-104 may also include a game client application, and the like, that is configured to enable an end-user to interact with and play a game, an interactive program, and the like. The game client may be configured to interact with a game server program, or the like. In one embodiment, the game client is configured to provide various functions, including, but not limited to, authentication, ability to enable an end-user to customize a game feature, synchronization with the game server program, and the like. The game client may further enable game inputs, such as keyboard, mouse, audio, and the like. The game client may also perform some game related computations, including, but not limited to audio, and visuals, rendering, and the like. In one embodiment, client devices 102-104 are configured to receive and store game related files, executables, audio files, graphic files, and the like, that may be employed by the game client, game server, and the like.

In one embodiment, the game server resides on another network device, such as GND 106. However, the invention is not so limited. For example, client devices 102-104 may also be configured to include the game server program, and the like, such that the game client and game server may interact on the same client device, or even another client device. Furthermore, although the present invention is described employing a client/server architecture, the invention is not so limited. Thus, other computing architectures may be employed, including but not limited to peer-to-peer, and the like.

Network 105 is configured to couple client devices 102-104, and the like, with each other, and to GND 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 105 may further employ a plurality of wireless access technologies including, but not limited to, 2nd (2G), 3rd (3G) generation radio access for cellular systems, Wireless-LAN, Wireless Router (WR) mesh, and the like. Access technologies such as 2G, 3G, and future access networks may enable wide area coverage for mobile devices, such as client device 102 with various degrees of mobility. For example, network 105 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link. In essence, network 105 includes any communication method by which information may travel between client devices 102-104 and GND 106, and the like.

Additionally, network 105 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

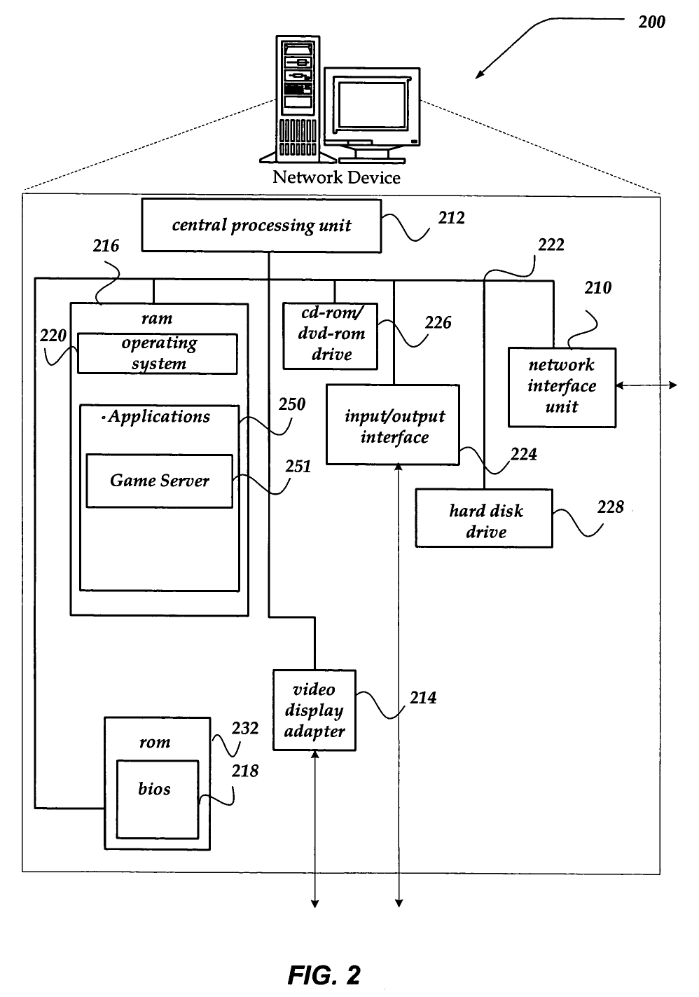

GND 106 is described in more detail below in conjunction with FIG. 2. Briefly, however, GND 106 includes virtually any network device configured to include the game server program, and the like. As such, GND 106 may be implemented on a variety of computing devices including personal computers, desktop computers, multiprocessor systems, microprocessor-based devices, network PCs, servers, network appliances, and the like.

GND 106 may further provide secured communication for interactions and accounting information to speedup periodic update messages between the game client and the game server, and the like. Such update messages may include, but are not limited to a position update, velocity update, audio update, graphics update, authentication information, and the like.

Illustrative Server Environment

FIG. 2 shows one embodiment of a network device, according to one embodiment of the invention. Network device 200 may include many more components than those shown. The components shown, however, are sufficient to disclose an illustrative embodiment for practicing the invention. Network device 200 may represent, for example, GND 106 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, such as network 105 in FIG. 1, via network interface unit 210, which is constructed for use with various communication protocols including the TCP/IP protocols. For example, in one embodiment, network interface unit 210 may employ a hybrid communication scheme using both TCP and IP multicast with a client device, such as client devices 102-104 of FIG. 1. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs may include transcoders, schedulers, graphics programs, database programs, word processing programs, HTTP programs, user interface programs, various security programs, and so forth. Mass storage may further include applications such as game server 251.

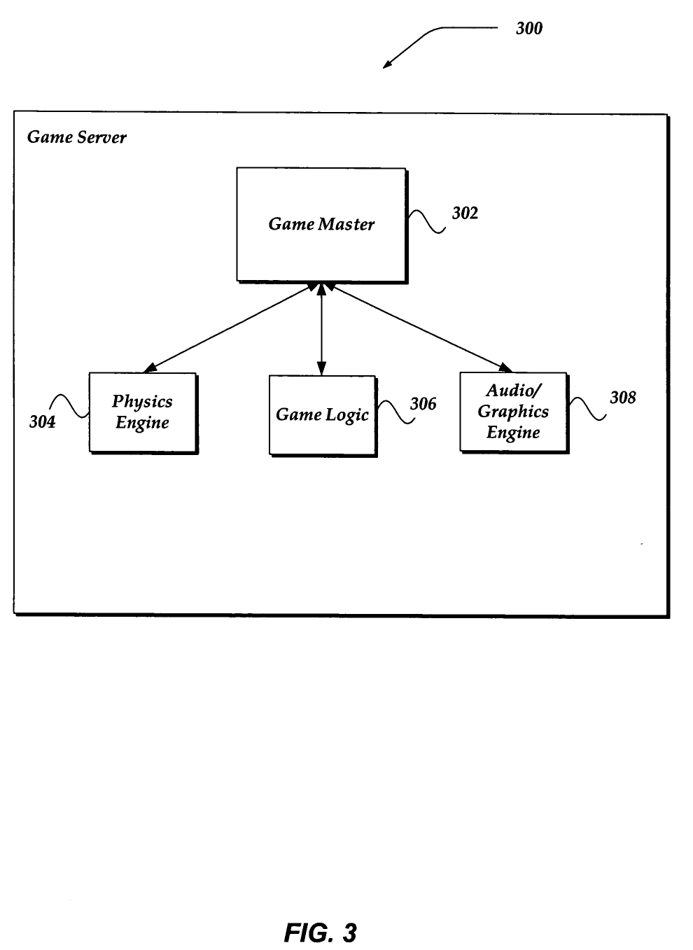

One embodiment of game server 251 is described in more detail in conjunction with FIG. 3. Briefly, however, game server 251 is configured to enable an end-user to interact with a game, and similar three-dimensional modeling programs. In one embodiment, game server 251 interacts with a game client residing on a client device, such as client devices 102-105 of FIG. 1. Game server 251 may also interact with other components residing on the client device, another network device, and the like. For example, game server 251 may interact with a client application, security application, transport application, and the like, on another device.

Network device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion. Moreover, network device 200 may further include applications that support virtually any secure connection, including but not limited to TLS, TTLS, EAP, SSL, IPSec, and the like.

Network device 200 also includes input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 may be utilized to store, among other things, application programs, databases, client device information, policy, security information including, but not limited to certificates, ciphers, passwords, and the like.

FIG. 3 illustrates a function block diagram of one embodiment of a game server for use in GND 106 of FIG. 1. As such, game server 300 may represent, for example, game server 251 of FIG. 2. Game server 300 may include many more components than those shown. The components shown, however, are sufficient to disclose an illustrative embodiment for practicing the invention. It is further noted that virtually any distribution of functions may be employed across and between a game client and game server. Moreover, the present invention is not limited to any one architecture, and another may be employed. However, for ease of illustration of the invention, a client/server architecture has been selected. Thus, as shown in the figure, game server 300 includes game master 302, physics engine 304, game logic 306, and audio/graphics engine 308.

Game master 302 may also be configured to provide authentication, and communication services with a game client, another game server, and the like. Game master 302 may receive, for example, input events from the game client, such as keys, mouse movements, and the like, and provide the input events to game logic 306, physics engine 304, audio/graphics engine 308, and the like. Game master 302 may further communicate with several game clients to enable multiple players, and the like. Game master 302 may also monitor actions associated with a game client, client device, another game server, and the like, to determine if the action is authorized. Game master 302 may disable an input from an unauthorized sender.

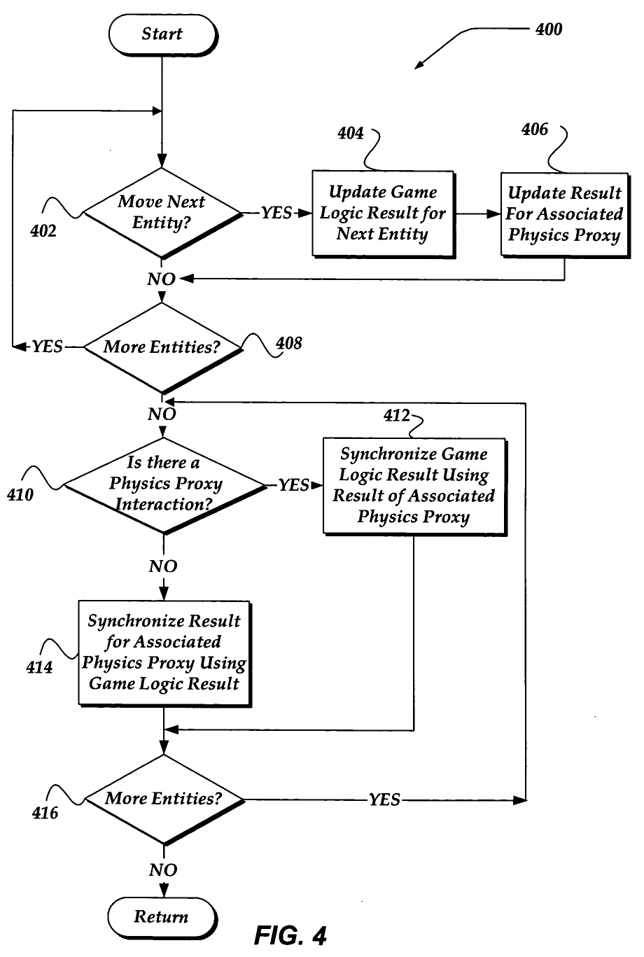

Game master 302 may further manage interactions between physics engine 304, game logic 306, and audio/graphics engine 308. For example, in one embodiment, game master 302 may perform substantially similar to process 400 described below in conjunction with FIG. 4.

Game logic 306 is also in communication with game master 302, and is configured to provide game rules, goals, and the like. Game logic 306 may include a definition of a game logic entity within the game, such as an avatar, vehicle, and the like. Game logic 306 may include rules, goals, and the like, associated with how the game logic entity may move, interact, appear, and the like, as well. Game logic 306 may further include information about the environment, and the like, in which the game logic entity may interact.

Physics engine 304 is in communication with game master 302. Physics engine 304 is configured to provide mathematical computations for interactions, movements, forces, torques, collision detections, collisions, and similar interactions, and the like. In one embodiment, physics engine 304 is a provided by a third party. However, the invention is not so limited and virtually any physics engine 304 may be employed that is configured to determine properties of entities, and a relationship between the entities and environments related to the laws of physics as abstracted for a virtual environment.

Physics engine 304 may determine the interactions, movements, forces, torques, interactions, collisions, and the like for a physics proxy. Virtually every game logic entity may have associated with it, a physics proxy. The physics proxy may be substantially similar to the game logic entity, including, but not limited to shape. In one embodiment, however, the physics proxy is reduced in size from the game logic entity by an amount epsilon. The epsilon may be virtually any value, including, but not limited to a value substantially equal to a distance the game logic entity may be able to move during one computational frame.

Audio/graphics engine 308 is in communication with game master 302 and is configured to determine and provide audio and graphical information associated with the overall game. As such, audio/graphics engine 308 may include a bump-mapping component for determining and rending surfaces having high-density surface detail. Audio/graphics engine 308 may also include a polygon component for rendering three-dimensional objects, a sound component for rendering various sounds, an ambient light component for rendering ambient light effects, and the like. However, audio/graphics engine 308 is not limited to these components, and others may be included, without departing from the scope or spirit of the invention.

Illustrative Operation for Synchronizing Entity Systems

The operation of certain aspects of the present invention will now be described with respect to FIG. 4. FIG. 4 illustrates a flow diagram generally showing one embodiment of a process of synchronizing a game result with a physics result. Process 400 of FIG. 4 may be implemented within GND 106 of FIG. 1.

Process 400 begins, after a start block, at decision block 402, where a determination is made whether a next entity is to move. Movement of the next entity may arise based on a variety of factors, including, but not limited to an input from a client device, a game rule, a reaction to another entity, scripted motion by a game author, a state in a character's artificial intelligence method, and the like. In any event, if the next entity is to move, processing proceeds to block 404; otherwise, processing proceeds to decision block 408.

At block 404, based, in part, on the received input, a game logic result associated with the next entity is updated. This update may result, for example, in a movement of the next entity from one location, position, orientation, or the like, to another location, position, orientation, or the like. Processing proceeds next to block 406, where a result for the physics proxy associated with the game logic entity is updated. The result of the physics proxy may be determined employing a physics engine such as described above in conjunction with FIG. 3.

The result of moving the physics proxy may include a collision with another entity, the environment, and the like. The result however, is not constrained to collisions, however. For example, non-collision interactions may also be included, including but not limited to, a magnetic repulsion, attraction, and the like. Computation of the collision, interaction, and the like, employing the physics engine may result in movement of the physics proxy to a location, orientation, and the like, that is substantially different from that determined by the game logic for the game logic entity. For example, the collision, or other interaction, may result in the physics proxy ‘bouncing’ off another entity, the environment, an object, or the like. Because the movement of the game logic entity does not typically include consideration of the laws of physics, the game logic entity may not ‘bounce,’ and the like. Thus, during a collision, or similar interaction between game entities, the environment, and the like, the results for the game logic entity may be different from the results for the physics proxy. In any event, processing proceeds to decision block 408.

At decision block 408, a determination is made whether there are more entities to consider. If there are more entities to consider, processing loops back to decision block 402, and possibly to blocks 404 and 406, until all entities have been considered. When there are no more entities to consider, processing flows to decision block 410.

At decision block 410, a determination is made whether there was a collision, non-collision interaction, or the like, associated with a physics proxy. If there was a collision, non-collision interaction, or the like detected, processing branches to block 412; otherwise, processing proceeds to block 414.

At block 412, for this collision, or interaction event, the result associated with the game logic entity is modified to be consistent with the result of the associated physics proxy. That is, the location, orientation, and the like for the game logic entity are synchronized with the result of the physics proxy to reflect the result of the collision, interaction, and the like. Moreover, a constraint may be applied to a derivative quantity, such as velocity, angular velocity, and the like. The application of the constraint is so that a next game step includes initial conditions that are consistent with a rule of the game. Processing proceeds to decision block 416, where a determination is made whether there are more entities to consider. If there are more entities, processing loops back to decision block 410; otherwise, processing returns to a calling process to perform other actions.

At block 414, the result associated with the physics proxy is modified, if substantially different, to be consistent with the result of the game logic entity. Processing proceeds to decision block 416, where a determination is made whether there are more entities to consider. If there are more entities, processing loops back to decision block 410; otherwise, processing returns to the calling process to perform other actions.

It is noted that while process 400, above, illustrates iterating over game characters, the invention is not so limited. For example, results associated with one game logic entity may first be determined, followed by a determination of a result for the associated with the physics proxy. The synchronization between the physics proxies and the game logic entities may then be performed. This may then be repeated over all relevant game entities, without departing from the scope of the invention.

Additionally, although the present invention is described in the context of a game, the invention is not so limited. For example, the present invention may be applicable to virtually any three-dimensional interactive program that employs a logic program and a physics engine that may provide differing results for a given entity.

Moreover, it will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

1. A method of managing an interactive three-dimensional program, comprising:
determining a result associated with a game logic entity;
determining another result for a physics proxy associated with the game logic entity; and
if an interaction is detected, synchronizing the result associated with the game logic entity to the other result for the physics proxy.

2. The method of claim 1, further comprising:
if the interaction is undetected, synchronizing the other result for the physics proxy to the result associated with the game logic entity.

3. The method of claim 1, wherein the game logic entity and the physics proxy differ in a dimension by an amount epsilon.

4. The method of claim 1, wherein synchronizing the result, further comprises, positioning the game logic entity to a substantially same location and a substantially same orientation as the physics proxy.

5. The method of claim 1, wherein a physics engine is utilized to detect an interaction with the physics proxy.

6. The method of claim 1, wherein the interactive three-dimensional program is utilized with a computer game.

7. The method of claim 1, wherein the method is adapted to operate within at least one of a client/server architecture, and a peer-to-peer architecture.

8. The method of claim 1, wherein the interaction further comprises at least one of a collision, and a non-collision interaction.

9. The method of claim 1, wherein the result associated with the game logic entity further comprises a movement based on at least one of a keyboard input, a mouse input, an audio input, a joystick input, a reaction to another game logic entity, and a game rule.

10. A server for managing a game system over a network, comprising:
a transceiver for receiving and sending information to a client device; and
a game master that is configured to perform actions, including:
receiving a request to perform an action upon a game logic entity;
determining a result associated with a game logic entity based, in part, on the request;
determining another result for a physics proxy associated with the game logic entity based, in part, on the request; and
if an interaction is detected with the physics proxy, synchronizing the result associated with the game logic entity to the other result for the physics proxy.

11. The server of claim 10, wherein the result associated with the game logic entity is determined by a game logic program.

12. The server of claim 10, wherein the result associated with the physics proxy is determined by a physics engine.

13. The server of claim 10, wherein the result associated with the physics proxy is determined based, in part, on an application of a physics law abstracted to a virtual environment.

14. The server of claim 10, wherein synchronizing the result, further comprises, positioning the game logic entity to a substantially same location and a substantially same orientation as the physics proxy.

15. The server of claim 10, wherein the game master is configured to perform actions, further comprising:
if the interaction is undetected, synchronizing the other result for the physics proxy to the result associated with the game logic entity.

16. A system for managing a game over a network, comprising:
a client that is configured to perform actions, comprising:
sending a request to perform an action; and
a server that is configured to perform actions, comprising:
receiving the request to perform the action;
determining a result associated with a game logic entity based, in part, on the request;
determining another result for a physics proxy associated with the game logic entity based, in part, on the request; and
if an interaction is detected with the physics proxy, synchronizing the result associated with the game logic entity to the other result for the physics proxy.

17. The system of claim 16, wherein determining the result associated with the game logic entity further comprises, determining the result based further on at least one of a game rule, an interaction with another game logic entity, and an interaction with an environment.

18. The system of claim 16, wherein the result associated with the physics proxy is determined by a physics engine.

19. The system of claim 16, wherein synchronizing the result further comprises, positioning the game logic entity to at least one of a substantially same location, and a substantially same orientation as the physics proxy.

20. The system of claim 16, wherein the game logic entity and the physics proxy differ in a dimension by an amount epsilon.

21. The system of claim 16, wherein the server is configured to perform actions, further comprising:
if the interaction is undetected, synchronizing the other result for the physics proxy to the result associated with the game logic entity.

22. A modulated data signal for managing a game system, the modulated data signal includes instructions for performing actions comprising:
sending a request to perform an action to a server;
enabling a determination of a result associated with a game logic entity based, in part, on the request;
enabling a determination of another result for a physics proxy associated with the game logic entity based, in part, on the request;
if a collision is detected with the physics proxy, enabling a synchronization at the server of the result associated with the game logic entity to the other result for the physics proxy; and
providing the synchronized result towards a client.

23. An apparatus for managing a game system, comprising:
a means for receiving a request to perform an action;
a means for determining a result associated with a game logic entity based, in part, on the request;
a means for determining another result for a physics proxy associated with the game logic entity based, in part, on the request; and
if a collision is substantially detected with the physics proxy, a means for synchronizing the result associated with the game logic entity to the other result for the physics proxy.
